(19) United States
(12) Patent Application Publication
(10) Pub. No.: US 2022/0166293 A1
(43) Pub. Date: May 26, 2022

(54) METHOD FOR REPAIRING SOLDER JOINT LEAKAGES AND WELDING OR SOLDERING APPARATUS FOR CARRYING OUT THE METHOD

(71) Applicant: Siemens Energy Global GmbH & Co. KG, Munich, Bayem (DE)

(72) Inventors: Christoph Döppe, Mulheim (DE); Dominik Halacz, Essen (DE)

(73) Assignee: Siemens Energy Global GmbH & Co. KG, Munich, Bayern (DE)

(21) Appl. No.: 17/432,512

(22) PCT Filed: Jan. 27, 2020
(86) PCT No.: PCT/EP2020/051853

§ 371 Date: Aug. 20, 2021

(30) Foreign Application Priority Data
Feb. 27, 2019 (DE) 10 2019 202 626.5

(51) Int. Cl. H02K 15/00; H02K 3/24; H02K 9/197; B23K 1/00; B23K 1/005; B23K 1/20

(52) U.S. Cl. CPC H02K 15/0006; H02K 3/24; H02K 9/197; B23K 2101/36; B23K 1/0056; B23K 1/206; B23K 1/0016

(57) ABSTRACT

A method for repairing solder joint leakages on a connection unit designed to feed cooling water into hollow metallic stator bars of a stator winding of an electrical machine. A welding or soldering apparatus is designed for carrying out the method.

### CROSS REFERENCE TO RELATED APPLICATIONS

This application is the US National Stage of International Application No. PCT/EP2020/051853 filed 27 Jan 2020, and claims the benefit thereof. The International Application claims the benefit of German Application No. DE 10 2019 202 626.5 filed (27 Feb. 2019. All of the applications are incorporated by reference herein in their entirety.

### FIELD OF INVENTION

The present invention relates to a method for repairing solder point leakages on a connection apparatus configured to introduce cooling water into hollow metallic stator bars of a stator winding of an electric machine, wherein the connection apparatus has: a metallic bar-receiving body with a through-opening in which the stator bars are pushed, aligned using metallic spacers and connected in a materially bonded and fluid-tight manner to the bar-receiving body and to the spacers using a solder, wherein the free ends of the stator bars terminate substantially flush with free ends of the spacers and with an end face of the bar-receiving body; a cup-shaped metallic covering element, which is connected in a materially bonded and fluid-tight manner to the bar-receiving body so as to enclose the free ends of the stator bars to form a cooling-water chamber; and a metallic cooling-water line connector, which is provided on the covering element and fluidically connected to the cooling-water chamber.

### BACKGROUND OF INVENTION

Connection apparatuses of the type mentioned at the outset are known in the prior art. They are used for example in generators to introduce cooling water into the hollow stator bars of a stator winding. An example of such a generator are generators from Siemens AG for large combined cycle power plants.

The bar-receiving body provided with a through-opening may for example be produced from copper and provided in the form of a square tube. The free end regions of the stator bars leading to the stator winding are pushed in the through-opening of the bar-receiving body and aligned within the opening using metallic spacers, which are likewise advantageously produced from copper. The stator bars, the spacers and the bar-receiving body are connected to one another in a materially bonded and fluid-tight manner using a solder to create a monolithic unit, with the result that cooling water can pass only through the hollow stator bars from one end face of the bar-receiving body to the other end face. The materially bonded solder connection is normally produced by covering the surfaces of the components to be joined with a solder and soldering said surfaces together by means of induction in a suitable soldering apparatus after corresponding alignment. A cup-shaped metallic covering element, which may likewise be produced from copper, is placed on that end face of the bar-receiving body with which the free ends of the stator bars and the free ends of the spacers terminate in a substantially flush manner. The covering element encloses the free ends of the spacers and is connected in a materially bonded and fluid-tight manner to the bar-receiving body to form a cooling-water chamber. Provided on the covering element is a metallic cooling-water line connector, which is fluidically connected to the cooling-water chamber and to a cooling-water reservoir. Correspondingly, during the operation of the generator, cooling water can be introduced via the cooling-water line connector into the cooling-water chamber and from there into the individual stator bars, with the result that said stator bars undergo cooling.

A problem with the above-described structure of the connection apparatus in practice is that the sealing of the solder points connecting the stator bars, the spacers and the bar-receiving body to one another in a materially bonded manner can weaken, this leading to undesired cooling-water leakages. The cause for the weakening sealing is usually that, in particular on account of crevice corrosion, cracks are induced and propagate from crevices which are present in the solder points and can arise during the manufacturing process of the connection apparatus.

Against this background, it is known that connection apparatuses of the type mentioned at the outset must be regularly maintained and/or repaired, in order to ensure the operation of the generator as intended. The repair is currently performed exclusively using what is known as the resin drawing method. In this method, in a first step, liquid resin is applied to the end face of the bar-receiving body that is situated opposite the covering element. In a second step, a vacuum is created in the cooling-water chamber, which leads to the resin penetrating into those cracks which extend continuously from the cooling-water chamber to the external end face of the bar-receiving body, as a result of which a seal is achieved.

Even though the resin drawing method has by all means proved to be of value in the past, it nevertheless has disadvantages. The most serious disadvantage is probably that only such cracks can be sealed that already cause a cooling-water leakage, that is to say cracks which connect the cooling-water chamber to the environment. In this way, leakages which are already present can indeed be eliminated. By contrast, a sealing of cracks which will lead to a leakage only in the near future is not possible. Against this background, it cannot be ruled out that new leakages also occur shortly after carrying out maintenance and/or repair of the type described above.

### SUMMARY OF INVENTION

Proceeding from this prior art, an object of the present invention is to provide an improved method for repairing solder point leakages on a connection apparatus of the type described above.

In order to achieve this object, the present invention provides a method of the type mentioned at the outset, characterized by the steps of: a) removing the covering element from the bar-receiving body; b) aligning and fastening a welding or soldering apparatus, which has a processing head movable in the x, y and z directions, on the electric machine in such a way that the processing head is positioned radially outward from the bar-receiving body, wherein the fastening is effected in particular to a region of the electric machine that is arranged radially inward from the bar-receiving body; c) overwelding or oversoldering solder points which have become accessible as a result of removing the covering element and connect the stator bars, the spacers and the bar-receiving body to one another in a materially bonded manner; d) removing the welding or soldering apparatus and d) fastening the covering element removed in step a) or a new covering element to the bar-receiving body in a materially bonded and fluid-tight manner. The present invention therefore proposes that welding points which are already the cause of leakages or at which it is possible that leakages will arise in the future are sealed off by overwelding or oversoldering with a filler material. In this way, leakage-free operation of the electric machine, which is in particular a generator, can be ensured at least until the next maintenance interval. The overwelding or oversoldering is effected according to the invention in situ at the installation site of the electric machine using a welding or soldering apparatus, which is fastened to the electric machine. Correspondingly, it is not necessary to dismount large components of the electric machine, such as for example the trunnion bearing or the rotor, which saves a lot of time and expenditure and thus associated costs.

Advantageously, the solder points to be overwelded are cleaned between steps a) and b). In this respect, the cleaning can be effected in the course of a mechanical processing, for example a grinding process, and/or using suitable cleaning means. In this way, the quality of the welding and/or soldering process carried out in step c) is improved.

The alignment of the welding or soldering apparatus advantageously takes place in step b) in such a way that at least some of the solder points extend in the x direction and/or in the y direction.

According to one configuration of the method according to the invention, in a first substep, exclusively a plurality of solder points extending in the x direction are overwelded or oversoldered and then, in a second substep, exclusively a plurality of solder points extending in the y direction are overwelded or oversoldered, or vice versa. Correspondingly, the processing head only has to be displaced in one direction during the overwelding or oversoldering of the solder points, this leading to simple control of the movement of the processing head.

Advantageously, between the performance of the two substeps, the processing head of the welding or soldering apparatus is rotated by 90° about an axis of rotation extending in the z direction. Correspondingly, the processing head only has to be displaced along a single axis when the solder points are being processed. This is of advantage in particular to the extent that the relative alignment of the processing head and the material feed can be maintained irrespective of whether solder points extending in the x direction or in the y direction are overwelded or oversoldered.

For the purpose of overwelding or oversoldering solder points which form a fillet weld, the processing head of the welding or soldering apparatus is advantageously pivoted about a pivot axis extending in the x direction or in the y direction, in particular by 45°. Correspondingly, a very good work result is ensured.

According to one configuration of the method according to the invention, all of the solder points which have become accessible as a result of removing the covering element are overwelded or oversoldered. As a result, it is also the case that solder points which, although currently not yet exhibiting any leakage, might possibly develop defects in the short term are likewise repaired.

The solder points are advantageously overwelded in step c), wherein a laser deposition welding method is used as the welding method, advantageously using a welding filler wire, in particular a micro laser deposition welding method. The laser deposition welding method is distinguished firstly in that very fine weld beads can be created. In this way, it can be ensured that the openings of the hollow stator bars do not become clogged with welding filler materials. Secondly, the laser deposition welding method is advantageous to the extent that only a small amount of heat is introduced into the component to be welded. Correspondingly, the situation in which components of the electric machine that are thermally connected to the bar-receiving body, such as for example insulating means which surround the stator bars emerging from the bar-receiving body, are adversely affected can be prevented.

To achieve the object stated at the outset, the present invention also provides a welding or soldering apparatus for carrying out a method according to the invention, comprising a processing head, a feed device for feeding a welding or soldering filler material, a frame, on which the processing head and the feed device can be displaced by a motor in an x direction and a y direction along corresponding linear axes and are held at least movably in a z direction along a further linear axis, and a fastening device, which is arranged below the frame and connected thereto and is configured to fasten the welding or soldering apparatus to an electric machine in such a way that the processing head is positioned radially outward from a bar-receiving body of a connection apparatus to be repaired.

According to one configuration of the present invention, the frame has a frame bottom part and a frame top part, on which frame top part the linear axes are mounted, wherein the frame top part can be pivoted relative to the frame bottom part about a pivot axis extending in the x direction or in the y direction, in particular at an angle of at least 45° to either side. Correspondingly, fillet welds can be processed very well.

The linear axes are advantageously held on the frame top part in such a way that they can be rotated relative to the frame bottom part between two positions by at least 90° about an axis of rotation extending in the z direction, and can be locked in the respective positions. This makes it possible to process solder points extending in the x direction and in the y direction by moving the processing head along only one axis. Correspondingly, a relative alignment of the processing head and the material feed device, such as a welding- or soldering-wire feed device, for example, can be maintained.

The fastening device advantageously has clamping jaws which are arranged opposite one another and can be pivoted about pivot axes extending parallel to one another in the x direction or in the y direction between a release position and a clamping position, in which clamping position said clamping jaws can be brought into engagement with the electric machine in a force-fitting, in particular form-fitting and force-fitting, manner. In this way, a very simple and stable structure of the fastening device is achieved.

Advantageously, the frame is fastened in particular detachably to a base plate which is provided with a cutout and can be fastened detachably to the fastening device in such a way wherein the clamping jaws are locked by the base plate in their clamping position, and wherein the cutout is dimensioned in such a way that it makes regions of the connection apparatus that are to be processed accessible in the mounted state of the welding or soldering apparatus on the electric machine. This also leads to a simple and stable structure of the welding or soldering apparatus.

According to one configuration of the present invention, the processing head is a laser processing head, in particular a fiber-laser processing head, which is connected to a laser source via a flexible fiber. The welding or soldering apparatus can be handled in situ correspondingly simply.

The feed device is advantageously designed for feeding a wire-shaped welding or soldering filler material.

### BRIEF DESCRIPTION OF THE DRAWINGS

Further features and advantages of the method according to the invention and the apparatus according to the invention will become clear on the basis of the following exemplary description with reference to the appended drawing, in which:

FIG. 1 shows a schematic, partially sectioned view of a connection apparatus;

FIG. 2 shows a view in the direction of the arrow II in FIG. 1;

FIG. 3 shows a perspective partial view of an electric machine, on which a welding or soldering apparatus according to one embodiment of the present invention is arranged;

FIG. 4 shows a perspective view of a fastening device of the welding or soldering apparatus in the state in which it is fastened to a stator bar;

FIG. 5 shows a perspective view of the arrangement illustrated in FIG. 4 while a base plate is being placed on;

FIG. 6 shows a perspective view of the welding or soldering apparatus fastened to the stator bar in the fully mounted state, wherein the welding or soldering apparatus is in a first position;

FIG. 7 shows a perspective view of the welding or soldering apparatus in a second position;

FIG. 8 shows a perspective view of the welding or soldering apparatus in a third position, and

FIG. 9 shows a view of the connection apparatus analogous to FIG. 2, after carrying out a method according to one embodiment of the present invention.

### DETAILED DESCRIPTION OF INVENTION

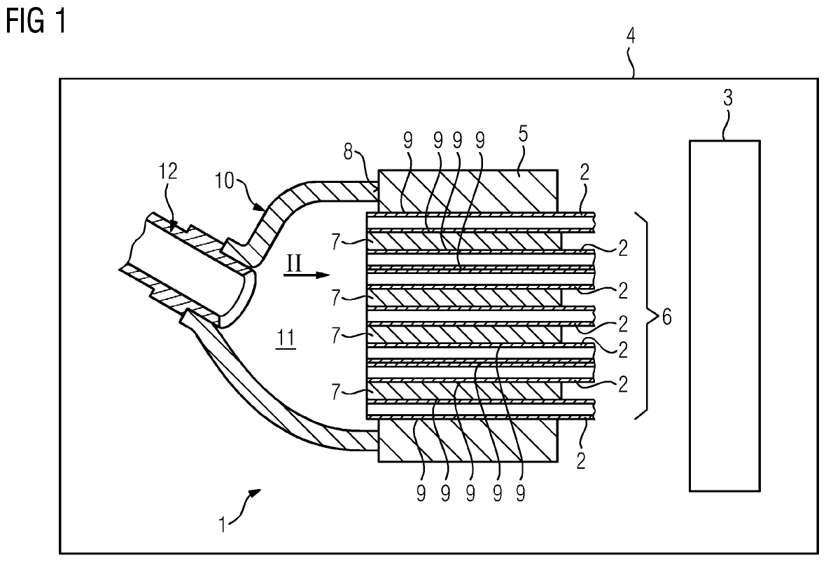

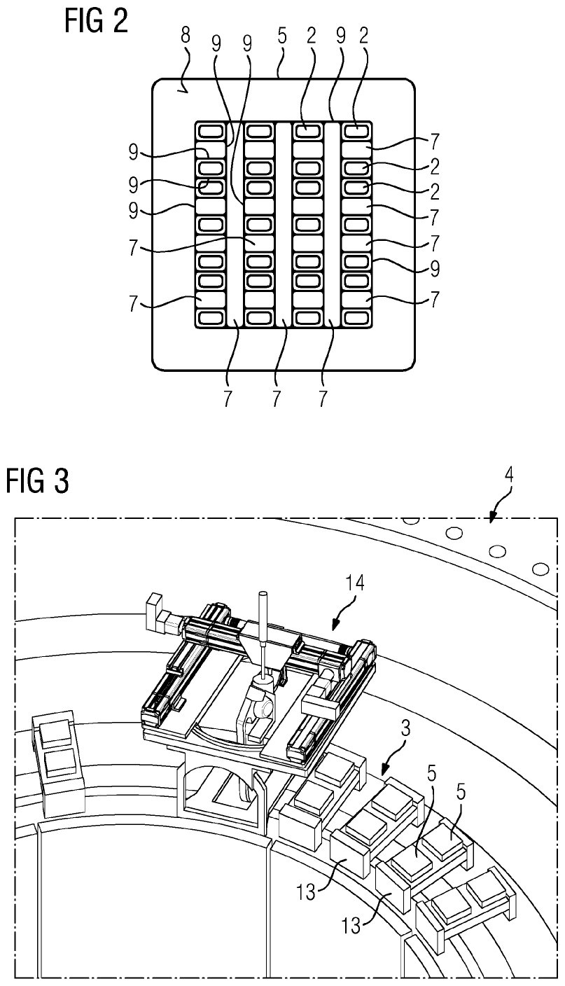

FIGS. 1 and 2 show views of a connection apparatus 1. Said connection apparatus is designed to introduce cooling water from a cooling-water reservoir or cooling-water circuit, not illustrated in more detail, into hollow metallic stator bars 2 of a stator winding 3 of an electric machine 4, which in the present case is a generator. The connection apparatus 1 comprises a metallic bar-receiving body 5, advantageously produced from copper, with a through-opening 6, which in the present case has a rectangular cross section. The end regions of the stator bars 2 leading to the stator winding 3 are pushed in the through-opening 6 and arranged and aligned using metallic bar-shaped spacers 7, likewise produced from copper, in such a way that the free ends of the stator bars 2 terminate substantially flush with the free ends of the spacers 7 and with an end face 8 of the bar-receiving body 5. The stator bars 2, the spacers 7 and the bar-receiving body 5 are connected to one another in a materially bonded and fluid-tight manner using a solder, wherein the resulting solder points are identified by the reference numeral 9. Correspondingly, a fluid can penetrate through the bar-receiving body 5 in principle only through the cavities of the stator bars 2. The connection apparatus 1 also comprises a cup-shaped metallic covering element 10, which is likewise advantageously produced from copper. The covering element 10 is formed and connected in a materially bonded and fluid-tight manner to the bar-receiving body 5 in such a way that it encloses the free ends of the stator bars 2 and the spacers 7 to form a cooling-water chamber 11. Provided on the covering element 10 is a cooling-water line connector 12, in the present case produced from stainless steel, which is fluidically connected to the cooling-water chamber 11 and leads to a cooling-water reservoir, not illustrated in any more detail, or is connected to a cooling-water circuit. Correspondingly, cooling water can be fed to the cooling-water chamber 11 via the cooling-water connector 12 and introduced into the respective stator bars 2, in order to cool the stator winding 3.

FIG. 3 shows a detail of the electric machine 4, illustrated only schematically in FIG. 1, the stator winding 3 of which is provided along its periphery with a multiplicity of the connection apparatuses 1 shown in FIG. 1. In this respect, two connection apparatuses 1, arranged radially adjacent, are assigned to each stator bar unit 13.

In order to eliminate leakages which are already present in the region of the solder points 9 of the respective connection apparatuses 1 or to prevent the formation of such leakages, which are usually caused by manufacturing-related crevices within the solder points 9, proceeding from which cracks are induced on account of crevice corrosion, the method according to one embodiment of the present invention that is described below is carried out:

In a first step, all of the covering elements 10 are removed from the bar-receiving bodies 5 of the respective connection apparatuses 1, for example by means of unsoldering. FIG. 3 shows the bar-receiving bodies 5 exposed in this way.

In a further step, the solder points 9 which have become accessible as a result of removing the covering element 10 are advantageously cleaned. The cleaning can be effected using a machining method, such as for example a grinding process, and/or using suitable cleaning means.

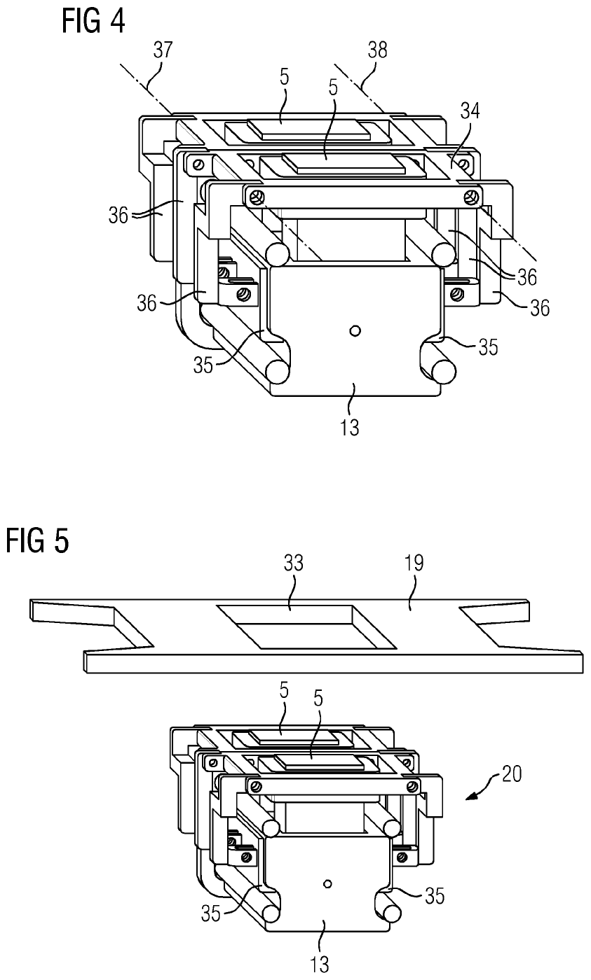

All of the solder points 9 which connect the stator bars 2, the spacers 7 and the bar-receiving body 5 of the respective connection apparatuses 1 to one another in a materially bonded manner are then overwelded or oversoldered in situ at the installation site of the electric machine 4. Used for this purpose in the present case is a welding or soldering apparatus 14 according to one embodiment of the present invention that is described below with reference to FIGS. 4 to 8.

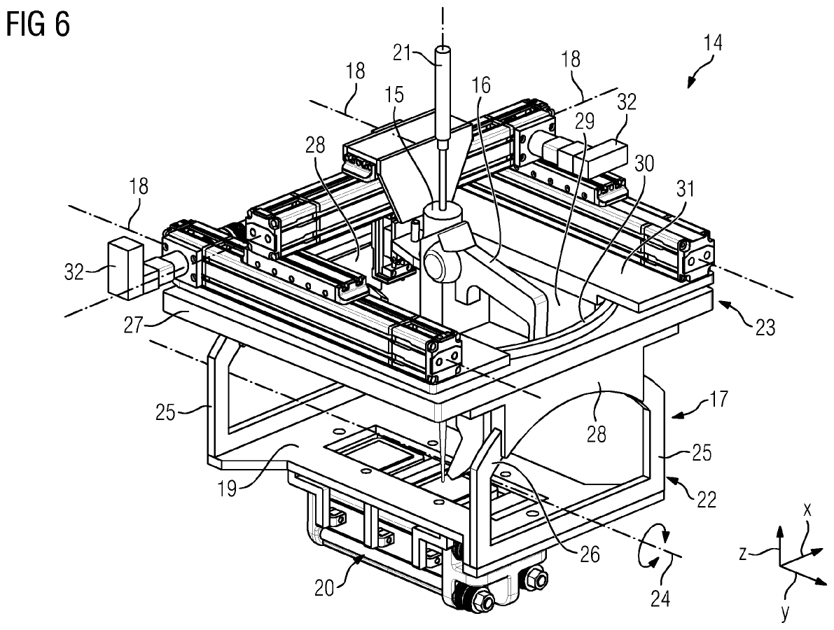

The welding or soldering apparatus 14 illustrated in FIGS. 6 to 8 comprises as main components a processing head 15, a feed device 16, a frame 17, on which the processing head 15 and the feed device 16 can be displaced by a motor in an x direction and in a y direction along corresponding linear axes 18 and are held manually movably in a z direction along a further linear axis 18, a base plate 19, on which the frame 17 is mounted, and a fastening device 20, which is arranged below the base plate 19 and is connected detachably thereto.

In the present case, the processing head 15 is a laser processing head, expressed more precisely a fiber-laser processing head, which is connected to a laser source, not illustrated in any more detail, via a flexible fiber 21.

The feed device 16 is designed to feed a wire-shaped welding or soldering filler material. The feed device 16 is held manually movably together with the processing head 15 on the linear axis 18 extending in the z direction, wherein adjusting means, not illustrated in any more detail and with which the processing head 15 and the feed device 16 can be aligned relative to one another, are provided.

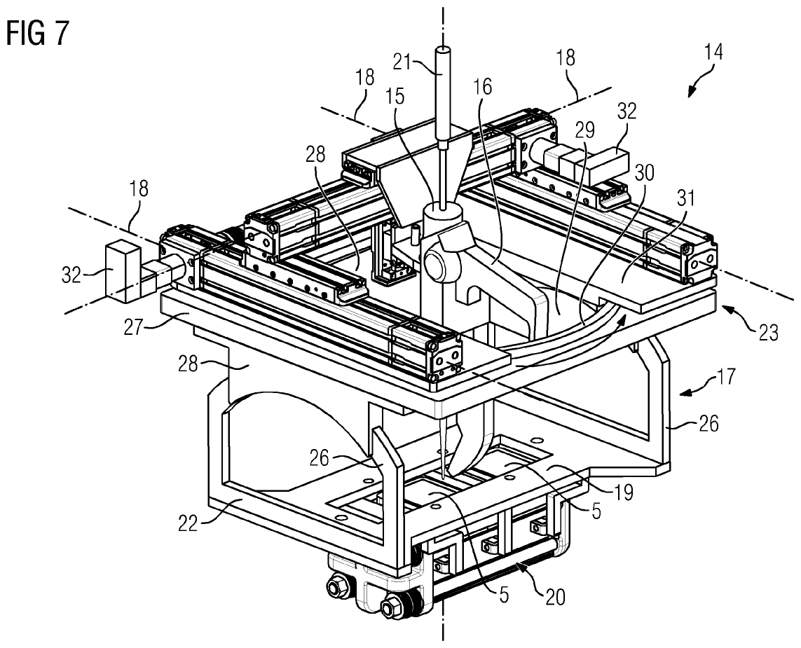

The frame 17 comprises a frame bottom part 22 and a frame top part 23, wherein the frame top part 23 can be pivoted relative to the frame bottom part 22 about a pivot axis 24 extending in the y direction. In the present case, the frame bottom part 22 has two frame parts 25, which are positioned opposite one another and define guides 26, which are curved in a circular ring segment shape in the top region. The frame top part 23 comprises a plate part 27, which is held via downwardly protruding arms 28 on the guides 26 of the frame bottom part 22 in such a way that it can be pivoted about the pivot axis 24 proceeding from an x-y plane respectively by 45° to either side and locked in each pivoting position. The plate part 27 is provided in the middle with a large through-opening 29, which is delimited by a circular, upwardly protruding guide 30. A U-shaped receiving plate 31 is held on this guide 30 in such a way that it can be rotated proceeding from the position illustrated in FIG. 6 by 90° about the z axis and locked in the two end positions. One of these end positions is illustrated in FIG. 7. Arranged on the receiving plate 31 in a mutually opposite manner are two of the linear axes 18, which extend parallel to one another in the y direction. Positioned on these two linear axes 18 in a manner movable in the y direction is a further linear axis 18 extending in the x direction, on which in turn in a manner displaceable in the x direction is held a linear axis 18 which extends in the z direction and receives the processing head 15 and the feed device 16 in a manner movable in the z direction. The movement of the processing head 15 and the feed device 16 in the x direction and y direction is realized via motors 32. An adjustment of the processing head 15 and the feed device 16 in the z direction is performed manually in the present case.

The base plate 19, on the top side of which the frame bottom part 22 is detachably fastened, comprises a middle cutout 33, which is dimensioned in such a way that it makes the solder points 9 of the connection apparatuses 1 of a stator bar unit 13 that are to be processed accessible from above when the welding or soldering apparatus 14 is placed on a stator bar unit 13 and fastened thereto.

The fastening device 20 comprises a double frame part 34, which is designed in such a way that it can be placed onto a stator bar unit 13 and in this state encloses the two bar-receiving bodies 5 of the stator bar unit 13. The fastening device 20 also has two clamping jaws 35, which are arranged opposite one another and in the present case are held pivotably on the double frame part 34 respectively via three pivot arms 36 such that they can be pivoted about pivot axes 37 and 38, extending parallel to one another in the y direction, between an upper release position and a lower clamping position. The shape and the position of the clamping jaws 35 are selected in such a way that, in the clamping position, the clamping jaws 35 can be brought into engagement with a stator bar unit 13 of the electric machine 4 in a form-fitting and advantageously also force-fitting manner. In the present case, the clamping jaws 35 are respectively formed by a plate which is bent in an L-shape.

In order to mount the welding or soldering apparatus 14 on a stator bar unit 13, in a first step the fastening device 20 is fastened to the stator bar 2. For this purpose, the double frame part 34 is placed onto the stator bar unit 13 in such a way that it uniformly encloses the bar-receiving bodies 5. In a further step, the clamping jaws 35 are transferred from the release position into the clamping position by being pivoted downward about the respective pivot axes 37 and 38. Now, the clamping jaws 35 bear against the stator bar unit 13 in a form-fitting and force-fitting manner, as shown in FIG. 4.

In a further step, the base plate 19, as shown in FIG. 5, is placed from above onto the fastening device 20 and fastened thereto using screws. The base plate 19 now lies directly on the pivot arms 36 of the fastening device 20, as a result of which the clamping jaws 35 are locked in their clamping position.

In a further step, the frame bottom part 22 with the remaining components of the welding or soldering apparatus 14 held thereon is then fixed to the base plate 19. In the present case, this is effected likewise using corresponding fastening screws. The welding or soldering apparatus 14 is now aligned in relation to the two bar-receiving bodies 5 of the stator bar unit 13 in such a way that the solder points 9 shown in FIG. 2 extend either in the x direction or in the y direction, as can be seen in FIG. 6.

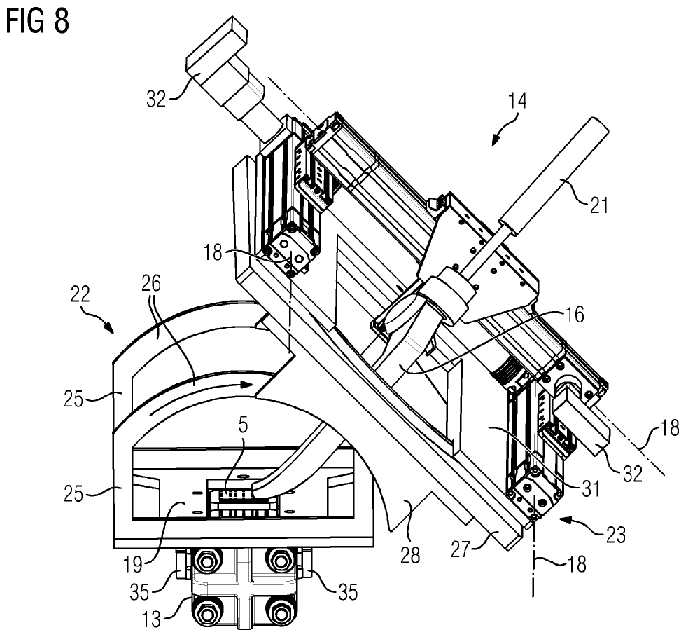

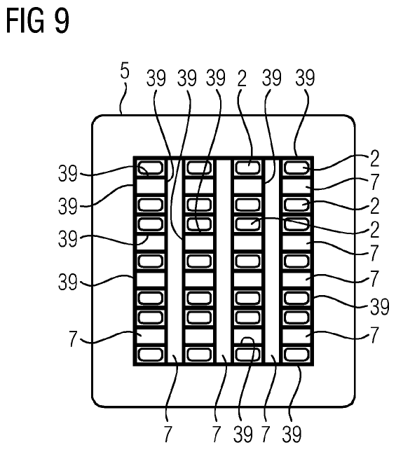

Now, the solder points 9 can be overwelded or oversoldered using the welding or soldering apparatus 14 in a manner known per se. In the present case, with the arrangement shown in FIG. 6, in a first substep exclusively the solder points 9 extending in the y direction are overwelded or oversoldered. The outer two fillet welds are excluded here. The processing head 15 and the feed device 16 are then rotated by 90° about the z axis proceeding from the arrangement illustrated in FIG. 6, resulting in the arrangement illustrated in FIG. 7. Now, in a second substep, the solder points 9 extending in the x direction are overwelded or oversoldered. In turn, the outer two fillet welds are excluded here. In order to overweld and oversolder the outer fillet welds, the processing head 15 and the feed device 16 are pivoted about the pivot axis, in particular by 45° to the respective side, as illustrated in FIG. 8. FIG. 9 shows the resulting weld beads 39, which should have a width of at most 3 mm in the transition region between the stator bars 2 and the spacers 7.

After all of the solder points 9 have been overwelded or oversoldered, the welding or soldering apparatus 14 is dismounted again and then remounted at the next stator bar unit 13, in order to overweld or oversolder the solder points 9 there.

After the solder points 9 of all of the stator bar units 13 of the stator winding 3 have been overwelded or oversoldered, in a final step, the covering elements 10 are then fastened to the bar-receiving bodies 5 again in a materially bonded and fluid-tight manner. This may involve those covering elements 10 that were previously removed. As an alternative, however, new covering elements 10 may also be used. The fastening is advantageously effected by means of soldering, in particular using a manually actuated soldering apparatus.

Although the invention has been illustrated and described in more detail by the exemplary embodiment, the invention is not restricted by the examples disclosed and a person skilled in the art is able to derive other variations therefrom without departing from the scope of protection of the invention.

1. A method for repairing solder point leakages on a connection apparatus configured to introduce cooling water into hollow metallic stator bars of a stator winding of an electric machine, wherein the connection apparatus has: a metallic bar-receiving body with a through-opening in which the stator bars are pushed, aligned using metallic spacers and connected in a materially bonded and fluid-tight manner to the bar-receiving body and to the spacers using a solder, wherein free ends of the stator bars terminate substantially flush with free ends of the spacers and with an end face of the bar-receiving body, a cup-shaped metallic covering element, which is connected in a materially bonded and fluid-tight manner to the bar-receiving body so as to enclose the free ends of the stator bars to form a cooling-water chamber; and a metallic cooling-water line connector, which is provided on the covering element and fluidically connected to the cooling-water chamber, the method comprising:
a) removing the covering element from the bar-receiving body,
b) aligning and fastening a welding or soldering apparatus, which has a processing head movable in x, y and z directions, on the electric machine in such a way that the processing head is positioned radially outward from the bar-receiving body, wherein the fastening is effected in particular to a region of the electric machine that is arranged radially inward from the bar-receiving body;
c) overwelding or oversoldering solder points which have become accessible as a result of removing the covering element and connect the stator bars, the spacers and the bar-receiving body to one another in a materially bonded manner,
d) removing the welding or soldering apparatus, and
e) fastening the covering element removed in step a) or a new covering element to the bar-receiving body in a materially bonded and fluid-tight manner.

2. The method as claimed in claim 1,
wherein the solder points to be overwelded or oversoldered are cleaned between steps a) and b).

3. The method as claimed in claim 1,
wherein the aligning of the welding or soldering apparatus takes place in step b) in such a way that at least some of the solder points extend in the x direction and/or in the y direction.

4. The method as claimed in claim 3,
wherein in a first substep, exclusively a plurality of solder points extending in the x direction are overwelded or oversoldered and then, in a second substep, exclusively a plurality of solder points extending in the y direction are overwelded or oversoldered, or vice versa.

5. The method as claimed in claim 4,
wherein between the first and second substeps, the processing head of the welding or soldering apparatus is rotated by 90° about an axis of rotation extending in the z direction.

6. The method as claimed in claim 1,
wherein for purposes of overwelding or oversoldering solder points which form a fillet weld, the processing head of the welding or soldering apparatus is pivoted about a pivot axis extending in the x direction or in the y direction.

7. The method as claimed in claim 1,
wherein in step c), all of the solder points which have become accessible as a result of removing the covering element are overwelded or oversoldered.

8. The method as claimed in claim 1,
wherein the solder points are overwelded in step c), and in that a laser deposition welding method is used as the welding method.

9. A welding or soldering apparatus designed for carrying out a method as claimed in claim 1, comprising:
a processing head,
a feed device for feeding a welding or soldering filler material,
a frame, on which the processing head and the feed device can be displaced by a motor in an x direction and a y direction along corresponding linear axes and are held at least movably in a z direction along a further linear axis, and
a fastening device, which is arranged below the frame and connected thereto and is configured to fasten the welding or soldering apparatus to an electric machine in such a way that the processing head is positioned radially outward from a bar-receiving body of a connection apparatus to be repaired.

10. The welding or soldering apparatus as claimed in claim 9,
wherein the frame has a frame bottom part and a frame top part, on which top part the linear axes are held, wherein the frame top part can be pivoted relative to the frame bottom part about a pivot axis extending in the x direction or in the y direction.

11. The welding or soldering apparatus as claimed in claim 10,
wherein the linear axes are held on the frame top part in such a way that they can be rotated relative to the frame bottom part between two positions by at least 90° about an axis of rotation extending in the z direction, and can be locked in the respective positions.

12. The welding or soldering apparatus as claimed in claim 9,
wherein the fastening device has clamping jaws which are arranged opposite one another and can be pivoted about pivot axes extending parallel to one another in the x direction or in the y direction between a release position and a clamping position, in which clamping position said clamping jaws can be brought into engagement with the electric machine in a force-fitting, or in form-fitting and force-fitting, manner.

13. The welding or soldering apparatus as claimed in claim 12,
wherein the frame is fastened detachably fastened to a base plate which is provided with a cutout and can be fastened detachably on the fastening device in such a way that the clamping jaws are locked by the base plate in their clamping position, wherein the cutout is dimensioned in such a way that it makes regions of the connection apparatus that are to be processed accessible in a mounted state of the welding or soldering apparatus on the electric machine.

14. The welding or soldering apparatus as claimed in claim 9,
wherein the processing head is a laser processing head, or a fiber-laser processing head, which is connected to a laser source via a flexible fiber.

15. The welding or soldering apparatus as claimed in claim 9,
wherein the feed device is designed for feeding a wire-shaped welding or soldering filler material.

16. The method as claimed in claim 6,
wherein the processing head of the welding or soldering apparatus is pivoted about a pivot axis extending in the x direction or in the y direction by 45°.

17. The method as claimed in claim 8,
wherein the laser deposition welding method uses a welding filler wire and/or is a micro laser deposition welding method.

18. The welding or soldering apparatus as claimed in claim 10,
wherein the frame top part can be pivoted relative to the frame bottom part about a pivot axis extending in the x direction or in the y direction at an angle of at least 45° to either side.
